(19) United States
(12) Patent Application Publication
(10) Pub. No.: US 2008/0302258 A1
(43) Pub. Date: Dec. 11, 2008

(54) SCREEN PRINTING STENCIL AND METHOD FOR MANUFACTURING THE SAME

(75) Inventors: Yong-Hong Zhang, Shenzhen (CN); Szu-Min Huang, Tayuan (TW); Chih-Yi Tu, Tayuan (TW)

Correspondence Address: PCE INDUSTRY, INC.;ATT. CHENG-JU CHIANG, 458 E. LAMBERT ROAD, FULLERTON, CA, 92835, US

(73) Assignees: FUKUI PRECISION COMPONENT (SHENZHEN) CO., LTD., Shenzhen City (CN); FOXCONN ADVANCED TECHNOLOGY INC., Tayuan (TW)

(21) Appl. No.: 11/933,975

(22) Filed: Nov. 1, 2007

(30) Foreign Application Priority Data
Jun. 8, 2007 (CN) 200710074784.2

(51) Int. Cl. B41C 1/14; B05C 17/06

(52) U.S. Cl. 101/128.4

(57) ABSTRACT

An exemplary screen printing stencil includes a frame, a screen mesh and a metal foil. The screen mesh is stretched tightly in the frame. The metal foil is attached on a surface of the screen mesh. A screen printing pattern is defined on the metal foil by a laser machining process. A machining tolerance of the screen printing pattern is either in a range from 0.005 to 0.02 millimeters or in a range from −0.02 to −0.005 millimeters. The screen printing stencil can be used in a screen printing process of manufacturing a printed circuit board, thereby improving quality of the printed circuit board.

### BACKGROUND

1. Technical Field

The present invention relates to stencils, more particularly to a screen printing stencil and a method for manufacturing the screen printing stencil.

2. Description of related art

Screen printing is a versatile printing technique. It can be used to print on a wide variety of substrates, including paper, paperboard, plastics, glass, metals and fabrics. Screen printing plays an important role in manufacturing a printed circuit board. In a screen printing process for manufacturing the printed circuit board, a stencil is placed over a substrate of the printed circuit board. A screen printing material (e.g., ink, resist, glue) is applied onto the top surface of the stencil. The screen printing material is then forced through the fine mesh openings of the stencil by drawing a scratch knife across the top surface of the stencil. The screen printing material will pass through the stencil, and thus a screen printing pattern is formed on the substrate of the printed circuit board.

Screen printing consists of three critical elements: the stencil, the scratch knife and the screen printing material. Because the stencil is a carrier of a screen printing pattern using in a subsequent printing process, a precision of the screen printing pattern formed on the substrate of the printed circuit board is mostly determined by a precision of the screen printing pattern of the stencil. The stencil can be made using a metal foil, a metal mesh, a silk, and nylon fabric. Generally, a metal foil stencil can be formed using a chemical etching method or a mechanical cutting method.

In the chemical etching method, a liquid photoresist is directly applied onto the metal foil. After drying, exposing and developing the liquid photoresist, the screen printing pattern used in a subsequent printing process is formed on the metal foil. The chemical etching method involves many processes, thereby making the stencil production time-consuming and labor-intensive. In the mechanical cutting method, a mechanical cutting apparatus directly cuts the metal foil to form the screen printing pattern used in the subsequent printing process in the metal foil. The screen printing pattern form using the mechanical cutting method may has high machining tolerance (i.e., a deviation between theoretical/predetermined position and actual position of the screen printing pattern). The mechanical cutting method may not form a complicated screen printing pattern in the metal foil yet, and thus quality of advanced printed circuit boards will be affected using the stencil.

What is needed, therefore, is a screen printing stencil for manufacturing advanced printed circuit board and a method for manufacturing the screen printing stencil.

### SUMMARY

One present embodiment provides a screen printing stencil. The screen printing stencil includes a frame, a screen mesh and a metal foil. The screen mesh is attached to the frame under tension. The metal foil is attached onto the screen mesh. A screen printing pattern is defined on the metal foil by a laser machining process. A machining tolerance of the screen printing pattern is either in a range from 0.005 to 0.02 millimeters or from −0.02 to −0.005 millimeters.

Another present embodiment provides a method for manufacturing a screen printing stencil. In the method, firstly, a laser beam is applied onto a metal foil to form a screen printing pattern in the metal foil. A machining tolerance of the screen printing pattern is either in a range from 0.005 to 0.02 millimeters or from −0.02 to −0.005 millimeters. Secondly, a screen mesh is attached to a frame under tension. Thirdly, the metal foil having the screen printing pattern therein is attached onto the screen mesh.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout the several views.

FIG. 1 is a schematic views of a screen printing stencil according to a preferred embodiment;

FIG. 2A is a schematic views of a metal foil having a screen printing pattern therein;

FIG. 2B is a schematic views of a frame having a screen mesh attached therein under tension; and

FIG. 2C is a schematic views of a metal foil having a screen printing pattern therein attached onto the screen mesh.

### DETAILED DESCRIPTION OF THE EMBODIMENTS

Embodiments will now be described in detail below and with reference to the drawings.

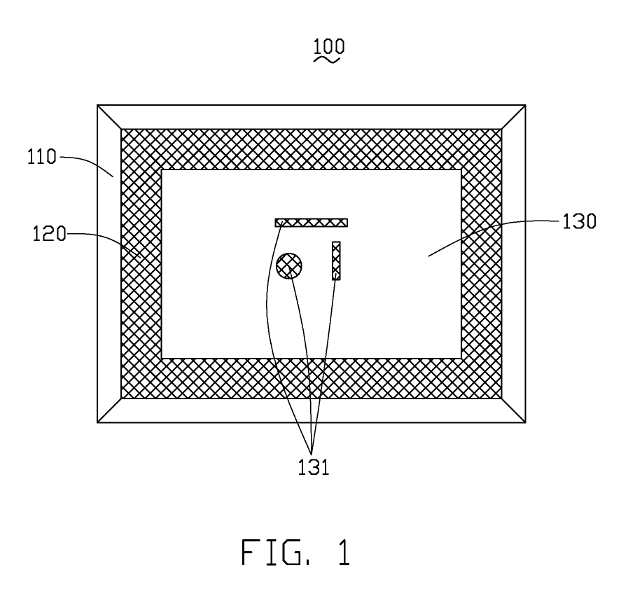

Referring to FIG. 1, an exemplary screen printing stencil 100 includes a frame 110, a screen mesh 120 and a metal foil 130.

The frame 110 can be made of a material selected from a group consisting of metal, wood and plastic. The frame 110 can be in various shapes according to various demands. The frame 110 is strong enough to withstand the pressures of the stretched screen mesh 120. In the present embodiment, the frame 110 is an aluminum alloy frame in a rectangular shaped.

The screen mesh 120 can be selected from a group consisting of a polyester screen mesh, a nylon screen mesh and a metal screen mesh. In the present embodiment, the screen printing mesh 120 is a polyester screen mesh. Peripheral edges of the screen mesh 120 are attached to inner sides of the frame 110, and thus the screen mesh 120 can be attached to the frame 110 under tension. The screen mesh 120 attached to the frame 110 has elasticity and tension.

The metal foil 130 has a screen printing pattern 131 formed therein. The metal foil 130 can have various thicknesses and shapes according to various demands. A size of the metal foil 130 is smaller than a size of the frame 110. The metal foil 130 can be made of aluminum or copper. In the present embodiment, the metal foil 130 is an aluminum foil in a rectangular shape. A thickness of the metal foil 130 is about 0.3 millimeters. The screen printing pattern 131 has a through-hole structure with desired shape. The screen printing pattern 131 is formed using a laser machining process. A machining tolerance of the screen printing pattern 131 can be in a range from 0.005 to 0.02 millimeters or from −0.02 to −0.005 millimeters. The machining tolerance refers to a deviation between theoretical/predetermined position and actual position of the screen printing pattern 131 in the metal foil 130.

The metal foil 130 is directly attached onto a surface of the screen mesh 120 attached to the frame 110. The metal foil 130 can be attached onto a surface of the screen mesh 120 with adhesive. Preferably, the metal foil 130 is disposed in the middle of the surface of the screen mesh 120.

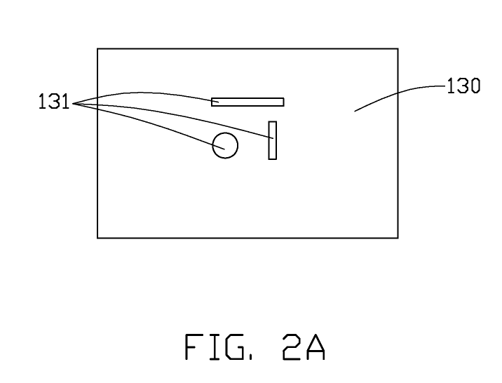

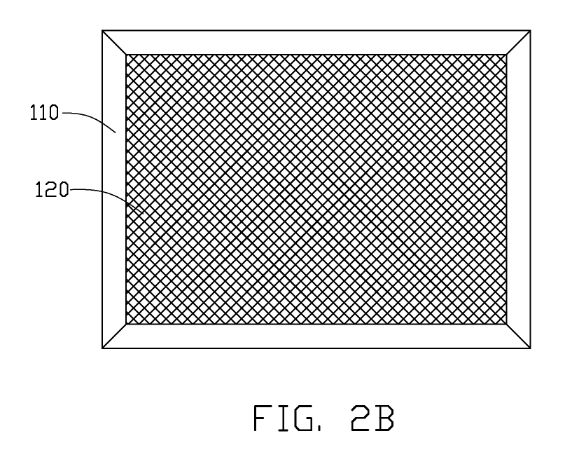

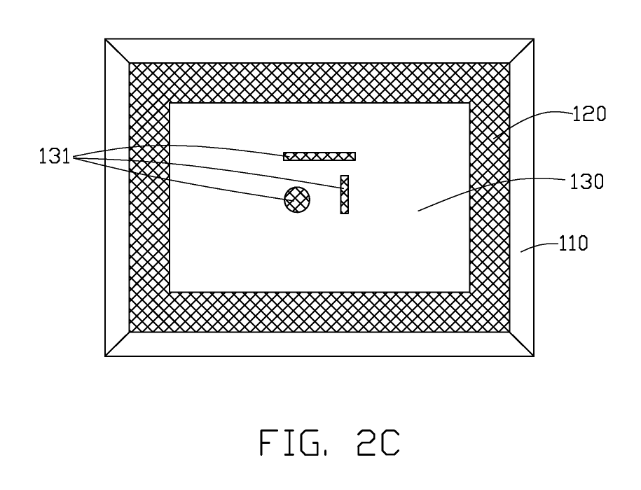

Referring to FIGS. 2A˜2C, an exemplary method for manufacturing the screen printing stencil 100 includes the following steps.

Step 1: a laser beam is applied onto the metal foil 130 to form a screen printing pattern 131. A machining tolerance of the screen printing pattern 131 can be in a range from 0.005 to 0.02 millimeters or from −0.02 to −0.005 millimeters.

Referring to FIG. 2A, a laser apparatus generates the laser beam to melt and remove portions of the metal foil 130 corresponding to a predetermined screen printing area of a printed circuit board so as to form the screen printing pattern 131. The laser apparatus can scan the predetermined screen printing area of the printed circuit board using an image sensor to obtain an image information. Then the laser apparatus orient the laser beam to ablate the metal foil 130 so as to melt and remove portions of the metal foil 130 corresponding to a predetermined screen printing area of a printed circuit board. As a result, the screen printing pattern 131 with high precision is formed in the metal foil 130. The screen printing pattern 131 is identical to the image of the predetermined screen printing area of a printed circuit board. A machining tolerance of the screen printing pattern 131 can be in a range from 0.005 to 0.02 millimeters or from −0.02 to −0.005 millimeters. The machining tolerance refers to a deviation between theoretical/predetermined position and actual position of the screen printing pattern 131 in the metal foil 130.

The laser beam generated can be an ultraviolet laser beam or a dioxide carbon laser beam. The ultraviolet laser beam can be a neodymium-yttrium aluminum garnet (Nd:YAG) laser beam. The dioxide carbon laser beam produces a beam of infrared light with the principal wavelength bands centering around 9.4 and 10.6 micrometers. An energy density of the laser beam can be determined according to the size of the screen printing pattern 131, and the thickness and the material of the metal foil 130.

Step 2: the screen mesh 120 is attached to the frame 110 under tension.

Referring to FIG. 2B, peripheral edges of the screen mesh 120 are attached to inner sides of the frame 110, and thus the screen mesh 120 is tightly stretched in the frame 110. Peripheral edges of the screen mesh 120 can be attached to inner sides of the frame 110 with adhesive or other suitable method. The screen mesh 120 attached to the frame 110 has elasticity and tension.

Step 3: the metal foil 130 having the screen printing pattern 131 therein is attached on a surface of the screen mesh 120 in the frame 110.

Referring to FIG. 2C, the metal foil 130 is attached onto the screen mesh 120 directly by gluing. A surface of the metal foil 130 contacts with and attaches onto a surface of the screen mesh 120 by applying glue onto the surface of the metal foil 130. It is noted that the glue can also be applied onto the surface of the screen mesh 120. The metal foil 130 can be attached onto anywhere of the surface of the screen mesh 120. Preferably, the metal foil 130 is disposed in the middle of the surface of the screen mesh 120.

While certain embodiments have been described and exemplified above, various other embodiments will be apparent to those skilled in the art from the foregoing disclosure. The present invention is not limited to the particular embodiments described and exemplified but is capable of considerable variation and modification without departure from the scope of the appended claims.

What is claimed is:

1. A screen printing stencil, comprising:
a frame;
a screen mesh attached to the frame under tension; and
a metal foil having a screen printing pattern defined by a laser machining process, the metal foil being attached onto the screen mesh, a machining tolerance of the screen printing pattern being either in a range from 0.005 to 0.02 millimeters or from −0.02 to −0.005 millimeters.

2. The screen printing stencil as claimed in claim 1, wherein the frame is comprised of a material selected form a group consisting of metal, wood and plastic.

3. The screen printing stencil as claimed in claim 1, wherein the frame is an aluminum alloy frame.

4. The screen printing stencil as claimed in claim 1, wherein the screen mesh is selected from a group consisting of a polyester screen mesh, a nylon screen mesh and a metal screen mesh.

5. The screen printing stencil as claimed in claim 1, wherein the screen printing pattern of the metal foil is defining using an ultraviolet laser and a dioxide carbon laser.

6. The screen printing stencil as claimed in claim 1, wherein the metal foil is comprised of a material selected form a group consisting of aluminum and copper.

7. A method for manufacturing a screen printing stencil, comprising the steps of:
applying a laser beam onto a metal foil to form a screen printing pattern therein, a machining tolerance of the screen printing pattern being either in a range from 0.005 to 0.02 millimeters or from −0.02 to −0.005 millimeters;
attaching a screen mesh to a frame under tension; and
attaching the metal foil having the screen printing pattern therein onto the screen mesh.

8. The method as claimed in claim 7 wherein the frame is comprised of a material selected form a group consisting of metal, wood and plastic.

9. The method as claimed in claim 7, wherein the screen mesh is selected from a group consisting of a polyester screen mesh, a nylon screen mesh and a metal screen mesh.

10. The method as claimed in claim 7, wherein the laser beam is selected from a group consisting of an ultraviolet laser beam and a dioxide carbon laser beam.

11. The method claimed in claim 7, wherein the metal foil is comprised of a material selected form a group consisting of aluminum and copper.

12. The method claimed in claim 7, wherein peripheral edges of the screen mesh are attached to inner sides of the frame with adhesive.

13. The method claimed in claim 7, wherein the metal foil is attached onto a surface of the screen mesh using glue.
